(19) United States
(12) Patent Application Publication
(10) Pub. No.: US 2009/0096276 A1
(43) Pub. Date: Apr. 16, 2009

(54) Wheel hub stress reduction system

(75) Inventors: Gary L. Orey, Portland, OR (US); Mark R. Brasch, Portland, OR (US)

Correspondence Address: AMSTED Industries Inc.;Two Prudential Plaza, Suite 1800, 180 N. Stetson, Chicago, IL, 60601, US

(73) Assignee: Consolidated Metco, Inc.

(21) Appl. No.: 11/907,726

(22) Filed: Oct. 16, 2007

(51) Int. Cl. B60B 1/00; B23P 19/00

(52) U.S. Cl. 301/35.632; 29/802

(57) ABSTRACT

One embodiment of the present invention is directed to a wheel hub stress reduction system for retaining a wheel on a vehicle using wheel nuts. The system includes a hub moon having a mounting portion defining a plurality of holes, and a plurality of threaded connectors each received by one of the holes. A maximum tensile stress region is produced in the hub when said connector is tensioned by a wheel nut threadably engaged therewith. The maximum tensile stress region lies beyond a hub radius which bisects said one of the holes. Another embodiment of the present invention is direct it to a method of reducing stress on a wheel hub retaining a wheel on a vehicle using wheel nuts.

### FIELD OF THE INVENTION

The present invention relates generally to a wheel hub stress reduction system which retains wheels on vehicles, such as semis or tractor-trailer trucks, and more particularly to a system employing a contoured connector which mates with a contoured hole defined by a vehicle hub.

### BACKGROUND

Conventionally, wheel hubs are formed of cast iron or aluminum, which are machined and assembled to mate with other components of a vehicle. For example, FIG. 8 is a sectional view of a radial portion of a generally bell-shaped wheel hub H attached in a conventional manner to a vehicle axle (not shown). A connector, such as a stud or bolt B extends through a bored cylindrical hole C defined by a mounting flange D of hub H extending from an interior surface E to an exterior surface F. While only a single bolt B is shown for simplicity, typically a plurality of holes C are equally spaced around the periphery of the hub mounting flange D, each receiving a bolt B, with the number and size of bolts and the bolt pitch circle diameter, depending upon the load rating of the vehicle.

The bolts B are used to secure together the hub H, sometimes a brake drum G, and a wheel W upon which is mounted a tire T. The bolts B each have a head J at one end, and a threaded portion K at the opposite end. A wheel nut L engages the bolt threaded portion K to secure the wheel W to the hub H. The bolt B has a serrated shoulder portion M which is typically press-fit into cylindrical hole C to affix the bolt to hub H. The bolt head J has undersurface N, which is substantially perpendicular to a longitudinal axis P of bolt B, and is seated substantially flat against the hub interior surface E.

When mounting wheel W to hub H, wheel nut L is tightened onto the bolt B, which imparts a tensile stress to the hub H in a direction perpendicular to axis P, and a compressive stress perpendicular to undersurface N. The tensile stress commonly occurs in a most critical region of the hub H, along a curved transition between mounting flange D and the barrel portion of hub H at a location radially inward from where material has been removed to form the holes C. The tensile stress may be represented in vector format as a arrow R having a force directed as indicated by the direction of the arrow, and a magnitude represented by the length of the arrow. This tensile stress is imparted to the hub H by the undersurface N of the bolt head J. A compressive stress is imparted by surface N, indicated by arrow S.

A vehicle hub H is typically subjected to two types of stress which limit service life: (1) the mean tensile stress imparted by tightening the wheel nuts, which has the effect of drawing the hub interior surface E down into hole C; (2) fatigue stress caused by a cyclic load generated when the hub rotates under load such as by cornering on turns. The residual tensile stress, when added to the cyclic stresses, has a negative impact on the service life of the hub H. Additionally, it is quite common for mechanics to over-tighten the wheel nuts L when changing tires, resulting in over-stretching or over-tensioning the bolts B and further increasing the tensile stress, which shortens the service life of the hub H.

### SUMMARY

One embodiment of the present invention is directed to a wheel hub stress reduction system for retaining a wheel on a vehicle using wheel nuts. The system includes a hub moon having a mounting portion defining a plurality of holes, and a plurality of threaded connectors each received by one of the holes. A maximum tensile stress region is produced in the hub when said connector is tensioned by a wheel nut threadably engaged therewith. The maximum tensile stress region lies beyond a hub radius which bisects said one of the holes. Another embodiment of the present invention is directed to a method of reducing stress on a wheel hub retaining a wheel on a vehicle using wheel nuts.

### BRIEF DESCRIPTION OF THE DRAWINGS

FIG. 1 is a perspective view of a wheel hub stress reduction system according to one embodiment of the invention.

FIG. 2 is an enlarged sectional view of a radial portion of the stress reduction system of FIG. 1.

FIG. 3 is a side elevational of view of one embodiment of a connector of FIG. 1.

FIG. 4 as a side elevational view of another embodiment of a connector.

FIG. 5 is an enlarged sectional view of a radial portion of a wheel hub stress reduction system according to another embodiment of the invention using the connector of FIG. 4.

FIG. 6 is a perspective stress diagram showing the tensile stress imparted to the hub when using the wheel hub stress reduction system of FIG. 1 or FIG. 5.

FIG. 7 is a perspective stress reduction diagram showing the tensile stress imparted to the hub when using a prior art hub and bolting system.

FIG. 8 is an enlarged radial, sectional view of a prior art hub and bolting system which produces the tensile stress illustrated in FIG. 7.

FIGS. 9A and 9B are enlarged sectional views each having a vector diagram, with FIG. 9A illustrating the prior art system of FIGS. 7 and 8, and FIG. 9B illustrating the system of FIGS. 1-3.

### DETAILED DESCRIPTION

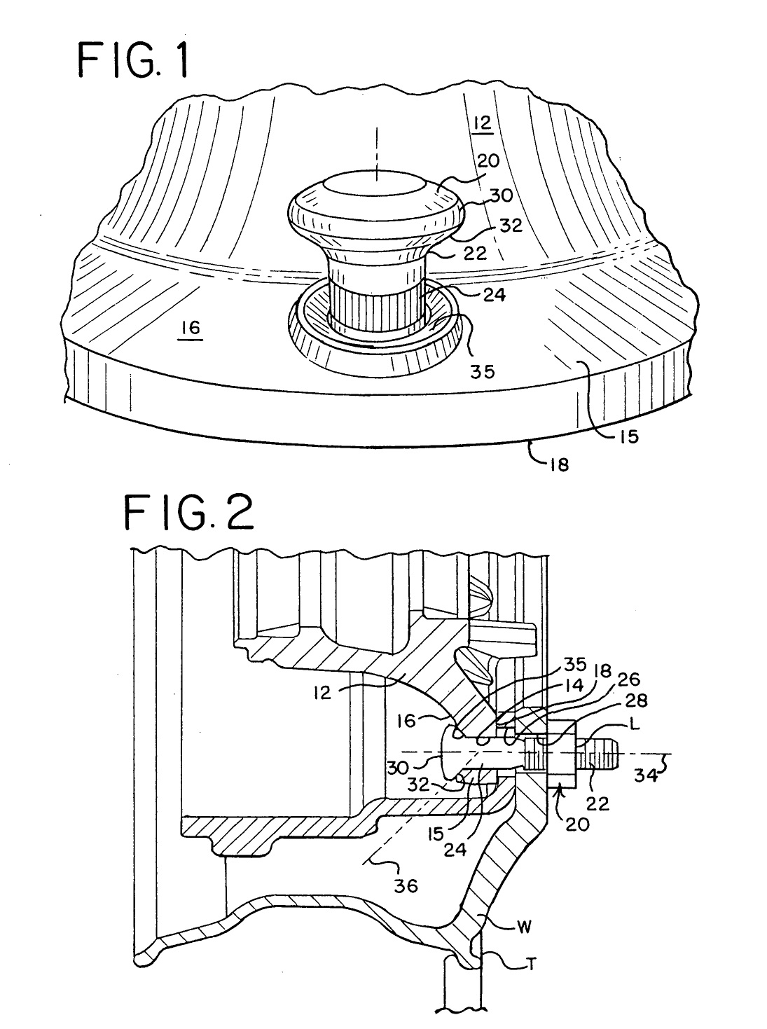

FIGS. 1 through 3 illustrate a wheel hub stress reduction system 10 according to one embodiment of the invention. As best shown in FIG. 2, system 10 includes a roughly bell-shaped wheel hub 12 having a barrel portion which attaches to an axle by bearings (not shown). A cylindrical hole 14, which may be formed by a boring operation, is defined by an outer peripheral mounting flange 15 of the hub 12. The hole 14 extends from an interior surface 16 to an exterior surface 18 of hub mounting flange 15.

A first embodiment of a connector, such as a wheel bolt 20, is illustrated with the shank 22 having a serrated shoulder 24 at one end, and a threaded portion 25 at an opposing end. The serrated shoulder 24 may be press fit into a cylindrical hole 14 of the hub mounting flange 15. The bolt shank 22 extends through a hole 26 defined by the brake drum G and a hole 28 defined by wheel W. A wheel nut L threadably engages the bolt threaded portion 25 to mount the tire T on hub 12. The bolt 20 has a head 30 with an undersurface 32 serving as a contact surface which has a contour centered about a longitudinal axis 34 of the bolt. Typically a plurality of holes 14 are equally spaced around the periphery of the hub mounting flange 15, each receiving a bolt 20, with the number of bolts depending upon the load rating of the vehicle.

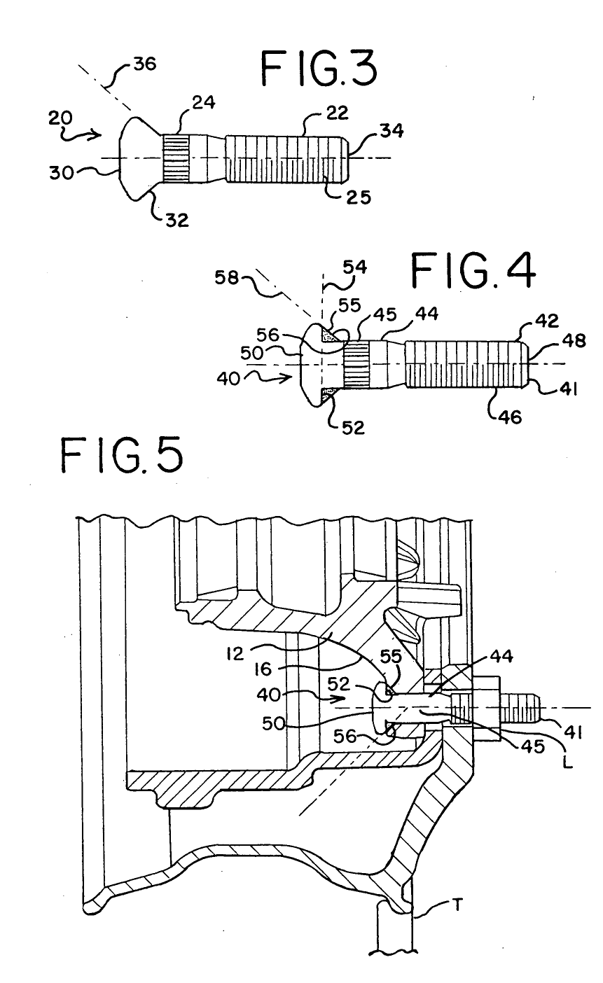

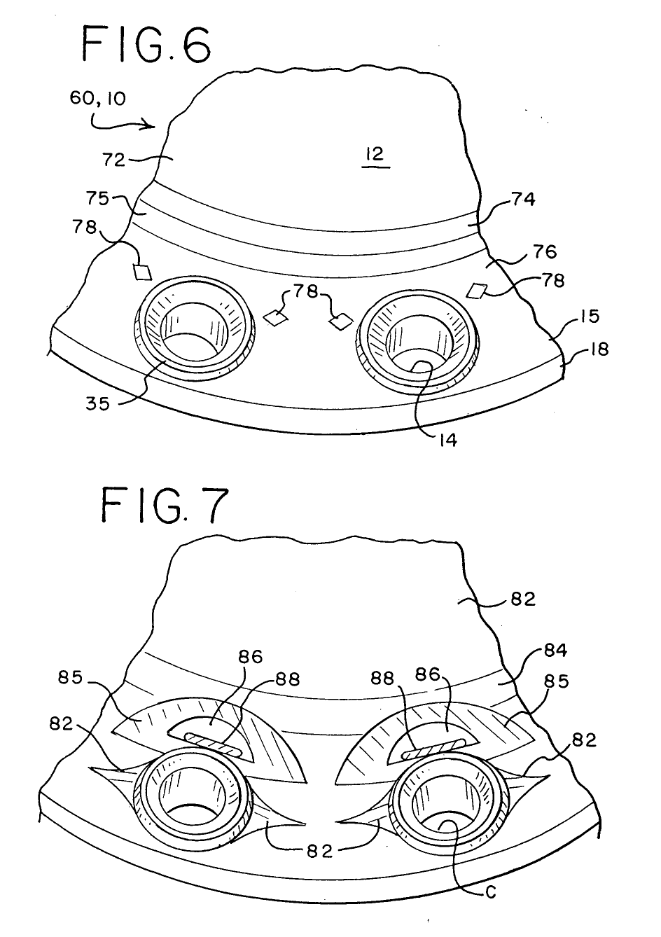

The hub mounting flange 15 defines a head seat 35 having a diameter greater than the cylindrical hole 14. The illustrated seat 35 has a contour which mates the bolt head undersurface 32, here shown as mating tapered or frusto-conical (also known as a “frustum” or “frustrum”) shapes. As best shown in FIG. 3, the bolt head undersurface 32 has an angle φ (“phi”) with respect to the bolt longitudinal axis 34, as indicated between the dashed lines 34 and 36, with dashed line 36 indicating a slope angle of the head undersurface 32 and head seat 35. In the drawings, this slope angle labeled φ (“phi”) is about 45°, although any angle selected in the range of 20° to 80° may be used. The effect on performance of using the illustrated tapered head 32 and tapered seat 35 is discussed below with respect to FIG. 6.

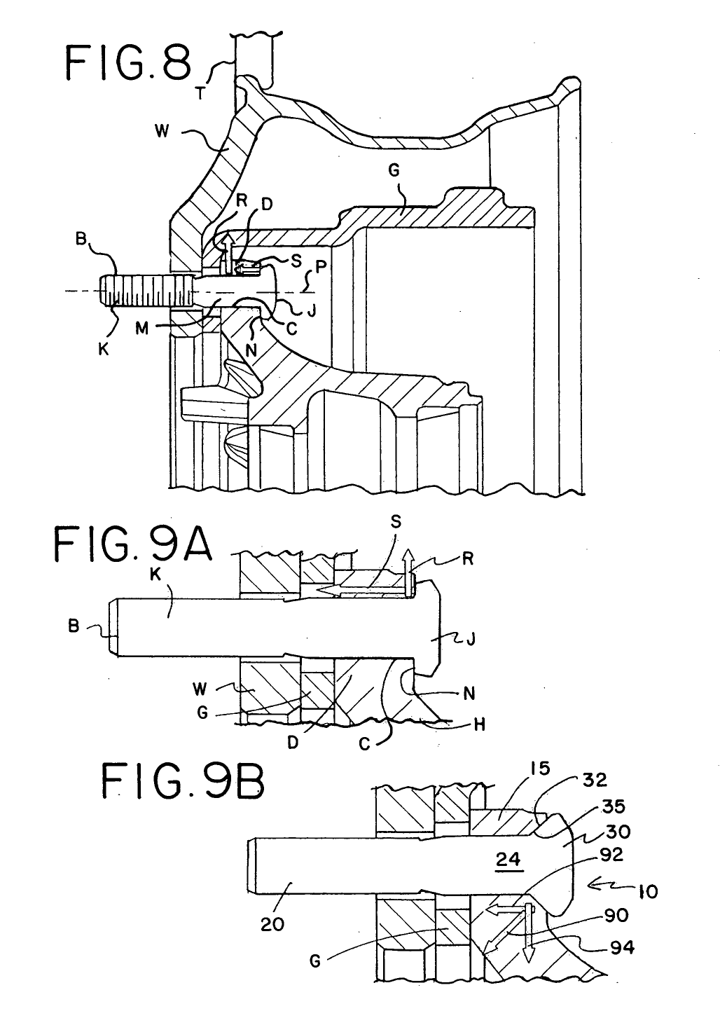

FIGS. 4 and 5 illustrate an alternate embodiment of a connector 40 according to the present invention. As best shown in FIG. 4, the connector 40 includes a hub bolt or bolt 41 having a shank 42. The shank 42 has a non threaded portion 44 at one end which may be optionally serrated to carry a plurality of serrations 45, and a threaded portion 46 at the opposing end. The bolt 41 has a longitudinal axis 48 upon which is centered a head 50 having an undersurface 52. In the drawings, the bolt head undersurface 52 has an angle θ (“theta”) with respect to the longitudinal axis 48, as indicated between dashed lines 48 and 54, with the dashed line 54 being coplanar with undersurface 52. In the illustrated embodiment, angle θ is about 90° so the head undersurface 52 is substantially perpendicular to the longitudinal axis 48, is illustrated for the prior art bolt B of FIG. 8 discussed in the Background section above.

The connector 40 includes a spacer member or washer 55 preferably sized to seat against the entire undersurface 52 of bolt head 50. The washer 55 has a triangular cross-section, illustrated as a right triangle to fit adjacent the mutually perpendicular interface of the head undersurface 52 and the periphery of shoulder 44. A remaining exposed surface 56 of washer 55 serves as a contact surface for connector 40. The contact surface 56 is selected to be at angle φ (“phi”) with respect to the longitudinal axis 48, as indicated in FIG. 4 between dashed lines 48 and 58. The angle φ may be selected as described above with respect to bolt 20 of FIGS. 1-3, allowing connector 40, comprising bolt 41 and washer 55, to be substituted for bolt 20.

The connector 40 may be constructed in a variety of different ways. For example, bolt 41 may be formed by cold heading or otherwise forming shoulder 44 and head 50 preferably from a steel material. The spacer member or washer 55 may be formed from a steel material in a stamping operation or other forming operation. Preferably, the bolt 41 is formed by cold heading and washer 55 is formed by stamping.

Following these initial forming operations, the washer 55 is mounted on the bolt shank 42 and seated against the head undersurface 52. The washer 55 may be held in place in a variety of different ways, yielding what is known as a captured washer. For example, after washer 55 is installed on shank 41, the serrations 45 may be formed on shoulder 44. The ridges of serrations 45 provide shank 41 with an outer diameter which is greater than the outer diameter of shoulder 44, and greater than the inner diameter of washer 55 to secure the washer to bolt 41. The threads 46 may be formed on shank 41 either before, after, or during formation of the serrations 45. As another example, the washer 55 may be compressed or pre-loaded to secure the washer against the head undersurface 52. In this example, serrations 45 and threads 46 may be formed either before or after washer 55 is installed on bolt 41.

FIG. 5 illustrates an alternate embodiment of a wheel hub stress reduction system 60 according to the present invention employing a connector 40. Here, the connector 40 is substituted for bolt 20 to couple together hub 12, brake housing G, and wheel W, using wheel nut L to mount a tire T on a vehicle. The interface surface 56 of washer 55 rests against the tapered head seat 35. Using washer 55 in connector 40 which moves or floats on a shank shoulder 44, which allows connector 40 to compensate for nonconcentricities of either the bolt head 50 or the cylindrical hub hole 14. The captured washer 55 promotes full contact of the seating surfaces 5*2 and 55 at all times during tightening of the wheel nut L.

As way of one example, FIGS. 6 and 7 are stress diagrams comparing the tensile stress imparted to a wheel hub 15 using either wheel hub stress reduction system 10 or 60 (FIG. 6), with the tensile stress imparted to a wheel hub H using the prior art system discussed in the Background Section (FIG. 7) for one specific case. FIG. 7 represents a typical case, and it has been found that the results are similar for other hub shapes. FIG. 6 illustrates a stress pattern 70 produced by stress reduction system 10 or 60. The stress pattern 70 shows different stress levels 72, 74, 75, 76 and 78, representing increasing levels of stress. FIG. 7 illustrates a stress pattern 80 on hub H produced by prior art bolts B. The stress pattern 80 shows different stress levels 82, 84, 85, 86 and 88 which represent increasing levels of stress. A comparison of the FIG. 6 and FIG. 7 stress levels, in percent (%) of the maximum stress level, is shown in Table 1 below.

TABLE 1
Stress Levels

| % of Max Stress Level | FIG. 6 | FIG. 7 (Prior Art) |
|---|---|---|
| 100 | | 88 |
| 90 | | 86 |
| 50 | 78 | |
| 45 | | 85 |
| 40 | 76 | |
| 20 | 75 | 84 |
| 15 | 74 | |
| 0 | 72 | 82 |

Of the three types of hub stress described in the Background section above, the stress diagrams of FIGS. 6 and 7 do not address the fatigue or cyclic stresses, only the mean tensile stress generated by tightening wheel nut L when mounting tire T on a vehicle. The prior art stress pattern of FIG. 7 shows regions of little or no stress 82 in the barrel portion of the generally bell-shaped hub H, and in pairs of triangular shaped regions extending from opposing sides of each bolt hole C. However, regions of extremely high stress 86 and 88 occurred tangentially along the inboard portion of each of bolt holes C. Transitional regions of stress 84 and 85 lie between the extremely high stress regions 86, 88 and the little or no stress regions 82.

FIG. 6 also has regions out of little or no stress 72 in the barrel portion of hub 12 and extending circumferentially between each of the bolt holes 14. The highest areas of stress 78 are pairs of small diamond shaped regions located on opposing sides of each hole 14 and lying in an annular band region encircling hub 12. Transitional regions of stress 74, 75 and 76 lie between stress regions 72 and 78. The highest levels of tensile stress 78 in stress reduction systems 10, 60 are roughly half of the highest stress levels 86, 88 experienced using a prior art hub H and bolt B design.

In addition to the significant reduction in the highest stress levels 78 experienced by the hub 12, the location of the highest stress levels is vastly improved using stress reduction systems 10, 60 over that of the prior art hub H and bolt B assembly of FIGS. 7 and 8. As discussed in the Background section above, the extremely high tensile stress 86, 88 occurs in a critical region of the hub H. This critical region is located along a curved transition between mounting flange D and the barrel portion of hub H, and at locations inboard from where material has been removed to form the holes C. The curved transition and the material removal each inherently weaken the hub in the critical region. The addition of placing a high tensile stress 86, 88 in this critical region, lying along the same radius as each hole C, results in a negative impact on the service life of hub H. The stress reduction systems 10, 60 move the highest stress regions 78 out of this critical region and away from any radius intersecting a hole 14 or the contoured seat 35.

One possible explanation for this repositioning of the highest stress regions 78 of systems 10, 60 from the critical region locations of the highest stress regions 86, 88 of the prior art shown in FIGS. 7 and 8 is illustrated in FIGS. 9A and 9B. FIG. 9A shows the resultant tensile stress as vector R imparted by the flat undersurface N and bolt head J in a radial direction.

FIG. 9B illustrates the effect of using a contoured seat 35 with a contoured contact surface 32 or 56, but for simplicity only system 10 is illustrated. Here, the contoured seat 35 is assumed to be in full contact with the bolt head contact surface 32 or 56. The total force imparted by bolt head 30 is represented by a vector 90 having a direction which is normal to, or perpendicular to, the contoured seat 32. Assuming the wheel nuts L in FIGS. 9A and 9B are each tightened with the same torque, the magnitude of the forces represented by vector S and vector 92 are equal, and thus, vectors S and 92 have the same length. Each head has an exposed surface which projects beyond said hub interior surface. As seen in FIG. 9B, each head seat has a first diameter at the interior surface and each head may have a second diameter greater than the first diameter wherein each head has an exposed surface which projects beyond said hub interior surface. Likewise, each of the holes 14 has a first circumference, and each seating surface 35 has a second circumference greater than the first circumference and each head contact surface 32 or 56 has a third circumference sized for a contact fit with said second circumference of said associated hub seating surface 35 when tightened by said wheel nut. In an alternative embodiment, the first diameter may be greater than the second diameter wherein the head has an exposed surface between the hub interior surface and hub exterior surface. In the alternative embodiment, the exposed surface is recessed below the hub interior surface.

Breaking down vector 90 into an x-y coordinate axis system, vector 90 has a vertical component shown as vector 92 and a horizontal component shown as vector 94. The terms “horizontal” and “vertical” are relative terms with respect to the view of FIG. 9B. These results were verified by the test data shown in FIGS. 6 and 7 for the maximum stress levels 78 and 86, 88, respectively. The horizontal stress vector 94 may impart a residual compressive stress in the critical region of hub 12. The horizontal stress vector 94 may also be responsible for moving the location of the highest stress levels 86, 88 in FIG. 7 to the location of the highest stress levels 78 in FIG. 6, which is out of a critical region.

Thus, the tensile stress reduction systems 10, 60 use a shape where the stud head 30, 50 is an angular design or taper that is seated in a countersunk hole 14, 35. This concept produces a lower tensile stress 78 in the critical region of the hub 12 because the forces from the stud mounting torque are directed normal to the connector contact surface 32, 56, instead of perpendicular to the prior art head undersurface N. This normal direction of the force indicated by vector 90 lowers the mean tensile force of the prior art system, indicated by the vector R, and may impart a residual compressive stress indicated by vector 94 in the critical region of hub 12. The shape of connector 20 has benefit as a monolithic one piece stud design. The two-piece assembled design 40 comprising stud 42 with captured washer 55 promotes full contact of contact surfaces 32, 56 with the contoured seat 32 at all times during tightening.

The present invention has been shown and described with reference to the foregoing exemplary embodiments. It is to be understood, however, that other forms, details, and embodiments may be made without departing from the spirit and scope of the invention which is defined in the following claims.

We claim:

1. A wheel hub stress reduction system for retaining a wheel on a vehicle using wheel nuts, comprising:
a hub having a mounting portion defining a plurality of holes; and
a plurality of threaded connectors each received by one of the holes and producing a maximum tensile stress region in the hub when tensioned by a wheel nut threadably engaged therewith, with the maximum tensile stress region lying beyond a hub radius which bisects said one of the holes.

2. A wheel hub stress reduction system according to claim 1 wherein:
the hub mounting portion comprises opposing interior and exterior surfaces with the plurality of holes extending therebetween; and
each threaded connector comprises a head retained at the hub interior surface and a threaded portion extending beyond the hub exterior surface to engage said wheel nut.

3. A wheel hub stress reduction system according to claim 2 wherein:
the hub interior surface defines a contoured seating surface; and
the head of each threaded connector has an contact surface contoured to rest against an associated hub seating surface when tightened by said wheel nut.

4. A wheel hub stress reduction system according to claim 3 wherein:
each of the plurality of holes has a first circumference;
each hub seating surface has a second circumference greater than said first circumference; and
each head contact surface has a third circumference sized for a contact fit with said second circumference of said associated hub seating surface when tightened by said wheel nut.

5. A wheel hub stress reduction system according to claim 3 wherein:
each of the plurality of holes has a first circumference;
each hub seating surface has a second circumference at the hub interior surface which is greater than said first circumference, with the seating surface gradually tapering in circumference between said first and second circumferences; and
each head contact surface gradually tapers in circumference for a contact fit with said associated tapering hub seating surface when tightened by said wheel nut.

6. A wheel hub stress reduction system according to claim 2 wherein:
the hub interior surface defines a contoured seating surface; and
each connector further comprises a spacer member adjacent an undersurface of the head, with the spacer member having a contact surface contoured to rest against an associated hub seating surface when tightened by said wheel nut.

7. A wheel hub stress reduction system according to claim 6 wherein:
each of the plurality of holes has a first circumference;
each hub seating surface has a second circumference greater than said first circumference; and
each spacer member contact surface has a third circumference sized for a contact fit with said second circumference of said associated hub seating surface when tightened by said wheel nut.

8. A wheel hub stress reduction system according to claim 6 wherein:
each of the plurality of holes has a first circumference;
each hub seating surface has a second circumference at the hub interior surface which is greater than said first circumference, with the seating surface gradually tapering in circumference between said first and second circumferences; and
each spacer member contact surface gradually tapers in circumference for a contact fit with said associated tapering hub seating surface when tightened by said wheel nut.

9. A wheel hub stress reduction system according to claim 6 wherein:
each connector comprises an elongate shank having the head formed at one end and a threaded portion at an opposing end of the shank, with the shank having a shoulder portion adjacent to the head portion, with the shoulder portion outer surface having a plurality of serrations formed;
said serrations forming a press fit with the hub holes when inserted therein;
the spacer member surrounds the shank; and
said serrations secure the spacer member adjacent to the head undersurface.

10. A method of reducing stress on a wheel hub retaining a wheel on a vehicle using wheel nuts, comprising:
forming a plurality of holes through a mounting portion of the wheel hub;
inserting one of a plurality of threaded connectors through an associated hole of said plurality of holes;
tensioning each inserted connector with a wheel nut threadably engaged therewith; and
producing a maximum tensile stress region in the hub after said tensioning, with the maximum tensile stress region lying beyond a hub radius which bisects said one of the holes.

11. A method of reducing stress according to claim 10, wherein:
said forming comprises forming a contoured seating surface for each associated hole; and
said tensioning comprises seating a contact surface of each inserted connector against the contoured seating surface of said associated hole.

12. A method of reducing stress according to claim 11, wherein:
each connector has an elongate shank with a threaded portion at one end and a head at an opposing end thereof, wherein the contact surface comprises a contoured undersurface of the head;
the forming step comprises forming said contoured seating surface to mate with the head contoured contact surface; and
said tensioning comprises tightening the wheel nut on the threaded portion of an associated connector and mating together the head contoured undersurface and the hub contoured seating surface.

13. A method of reducing stress according to claim 12, wherein:
the contoured undersurface of each connector head comprises a frusto-conical shape; and
said forming comprises contouring each seating surface as a frusto-conical shape.

14. A method of reducing stress according to claim 11, wherein said forming comprises:
forming each hole with a first circumference through between interior and exterior surfaces of the hub of mounting portion; and
forming each contoured seating surface adjacent said hub interior surface with a second circumference greater than the first circumference and substantially concentric therewith.

15. A method of reducing stress according to claim 11, wherein:
each connector comprises an elongate shank having a threaded portion at one end and a head at an opposing end thereof, and a spacer member adjacent an undersurface of the head, wherein said contact surface comprises an exterior surface of the spacer member, said exterior surface having a contour;
the forming step comprises forming said contoured seating surface to mate with the spacer member contoured contact surface; and
said tensioning comprises tightening the wheel nut on the threaded portion of an associated connector and mating together the spacer member contoured contact surface and the hub contoured seating surface.

15. A method of reducing stress according to claim 11, wherein:
each spacer member has a generally right triangular shaped cross-section, comprising a first leg surface adjacent the shank, a second leg surface adjacent the head undersurface, and a hypotenuse surface forming the exterior contoured contact surface; and
said forming comprises contouring each seating surface as a frusto-conical shape.

16. A method of reducing stress according to claim 15, wherein:
each spacer member has a generally right triangular isosceles shaped cross-section; and
said forming comprises contouring each seating surface as a right frusto-conical shape having an angle of about 45° between a conical surface and base of said shape.

17. A method of reducing stress according to claim 10, further comprising constructing the threaded connector, said constructing comprising:
providing a shank having opposing first and second ends;
forming a head at the shank first end;
threading a portion of the shank adjacent the second end;
providing the shank with a shoulder portion adjacent the head;
mounting a spacer member on the shank adjacent the head; and
following said mounting, securing the spacer member on the shank.

18. A method of reducing stress according to claim 17, wherein said securing comprises serrating the shoulder portion to secure the spacer member on the shank.

19. A method of reducing stress according to claim 18, further comprising press-fitting the shoulder portion of each shank into said associated hole in the hub mounting portion.

20. A system for retaining a wheel on a vehicle using wheel nuts, comprising:
a hub having a mounting flange defining a plurality of holes extending between opposing interior and exterior surfaces thereof, with the hub further defining a plurality of head seats each recessed from said interior surface and surrounding an associated hole of said plurality of holes; and
a plurality of connectors each press fit into an associated hole of said plurality of holes, each connector having a threaded portion extending beyond said exterior surface to engage a wheel nut, and a contact surface recessed below said interior surface, with the contact surface resting against the head seat.

21. A system according to claim 20, wherein:
each connector comprises a shank having the threaded portion at one end thereof and a head at an opposing end of the shank; and
each connector contact surface comprises an undersurface of the head.

22. A system according to claim 21, wherein:
each hole has a first circumference;
each associated head seat has a second circumference greater than the first circumference; and
each head contact surface has a third circumference selected to mate with the head seat at the second circumference.

23. A system according to claim 22, wherein:
each head seat tapers in circumference between the first and second circumferences; and
each head surface comprises a tapered contact surface.

24. A system according to claim 21, wherein:
each connector comprises a shank having the threaded portion at one end thereof and a head at an opposing end of the shank, and a spacer member surrounding the shank adjacent the head; and
each connector contact surface comprises an exposed surface of the spacer member.

25. A system according to claim 24, wherein:
each hole has a first circumference;
each associated head seat has a second circumference greater than the first circumference; and
each spacer exposed contact surface has a third circumference selected to mate with the head seat at the second circumference.

26. A system according to claim 25, wherein:
each head seat tapers in circumference between the first and second circumferences; and
each spacer exposed contact surface comprises a tapered contact surface.

27. A system according to claim 20, wherein each connector when received by said associated hole produces a maximum tensile stress region in the hub when tensioned by a wheel nut threadably engaged therewith, with the maximum tensile stress region lying beyond a hub radius which bisects said associated hole.

28. A system according to claim 20, wherein:
each head seat comprises a frusto-conical recess tapering from said interior surface toward said associated hole; and
each connector contact surface comprises a frustoconical shape.

29. A system according to claim 20 wherein:
each head seat has an exposed surface which projects beyond said hub interior surface.

30. A system according to claim 20 wherein:
each head seat has a first diameter at the interior surface; and
each head has a second diameter greater than the first diameter.

31. A system according to claim 20 wherein:
each head has an exposed surface between said hub interior surface and said exterior surface.
